(19) United States
(12) Patent Application Publication
(10) Pub. No.: US 2010/0167230 A1
(43) Pub. Date: Jul. 1, 2010

(54) HEATING DENTAL MATERIALS WITH A HEAT PACK

(76) Inventors: PAUL R. PIERSON, Camden, DE (US); Robert V. Hare, Georgetown, DE (US)

Correspondence Address: DENTSPLY INTERNATIONAL INC, 570 WEST COLLEGE AVENUE, YORK, PA, 17404, US

(21) Appl. No.: 12/719,374

(22) Filed: Mar. 8, 2010

Related U.S. Application Data
(63) Continuation of application No. 11/368,177, filed on Mar. 3, 2006, now abandoned.
(60) Provisional application No. 60/658,682, filed on Mar. 4, 2005.

(51) Int. Cl. A61C 3/00

(52) U.S. Cl. 433/32

(57) ABSTRACT

A heat pack 30 is provided which contains the reactants for an exothermic chemical reaction. The heat pack 30 having physical contact with or close physical proximity to a package 10 during the ensuing exothermic reaction causes package 10 and material contained within package 10 to be heated.

### RELATED APPLICATIONS

This application is a Continuation of U.S. patent application Ser. No. 11/368,177 filed Mar. 3, 2006, which claims the benefit of U.S. Provisional Application Ser. No. 60/658,682 filed on Mar. 4, 2005 (LDC-972-1).

### TECHNICAL FIELD

The present invention generally relates to the delivery of materials such as dental materials. More particularly, the invention relates to heating such materials prior to or during their delivery or other intended use, such as delivery to the oral cavity. Specifically, the invention relates to the use of an exothermic chemical reaction heat pack to warm the materials and/or the material delivery device or devices.

### BACKGROUND OF THE INVENTION

In the art of dispensing dental materials, it is common practice to provide the dental professional with devices which are pre-loaded with cements, filling material, restoratives, adhesives, bonding agents, composites, and the like. Often such devices take the form of an cartridge or cartridge, which is inserted into a handheld delivery gun or the like having operating handles or levers and, by operation thereof, desired amounts of the material in the cartridges are discharged readily and precisely. It is often the case in dentistry that relatively small quantities of such materials are used in a given application. Therefore, such materials are often packed in one-time use cartridges in approximately single use amounts or “unit doses”.

One example of a cartridge of interest to the present invention comprises the subject matter of prior U.S. Pat. No. 4,391,590 assigned to the assignee of the present invention, and hereby incorporated by reference in its entirety for such disclosure. In the patented structure, the body of the cartridge is cylindrical and of uniform inner diameter and in which a discharge piston is mounted in position in the open filling end of the cartridge to form both a closure and an ejecting piston. Cartridges of this type are miniature and, by way of example, have an outer diameter of about one quarter inch and an inner diameter of approximately one eighth inch. The piston, accordingly, has a complementary outer diameter of about one eighth inch and at present is composed of solid plastic material. An example of a cartridge heretofore known in the art is sold by DENTSPLY International Inc. of York, Pa., under the registered trademark COMPULES.

While such cartridges have enjoyed widespread use, there is always a difficulty in dispensing highly filled and highly viscous dental materials. It is generally known that heating the dental material may help to temporarily reduce its viscosity and assist in the subsequent delivery of the material to the patient. Other dental materials that are not delivered with an cartridge, cartridge, syringe or gun may still benefit from being heated prior to use. For example, heating may not only assist in the delivery of the material by whatever means, but may also initiate, propagate or otherwise assist in polymerization or other reactions. In short, a wide variety of dental materials may benefit from heating for a wide variety of purposes.

An example of a dental material that benefits from heating is described in co-pending U.S. Pat. App. Ser. No. 60/630,495 which is hereby incorporated by reference for such disclosure. The material of that pending application unexpectedly reduces its viscosity at elevated temperatures. For example, the material is extrudable from an cartridge upon reaching 50 to 60 degrees C., it is packable at 35 to 37 degrees C., and it is substantially solid at room temperature.

A variety of other dental materials such as dental composites are currently marketed. These dental composites have a wide range of viscosity. Some of these composites have high viscosity , which makes it difficult for them to be extruded from the primary package, which is often a syringe or cartridge. One way to reduce the extrusion force is to apply heat to the material and package. Warming the material reduces its viscosity and decreases extrusion force.

In the case of the material of U.S. Pat. App. Ser. No. 60/630,495, it was found that warming the cartridge containing the material in a microwave oven or with a commercially available cartridge warmer did allow the material to flow as desired. A problem with both of those heating systems is that they require extra equipment that takes up a large amount of counter space and that such equipment is generally expensive to obtain and operate.

A need exists therefore for an efficient and simple device and procedure for heating dental materials.

### SUMMARY OF THE INVENTION

According to the present invention, dental materials are heated using exothermic chemical reactions. The reactive components are preferably contained within a package termed a “hot pack”. These Hot Packs preferably utilize a dry chemical reaction that produces heat. Any hot pack chemistry that produces heat in the proper range is within the scope of the invention. One useful chemical system comprises iron powder, water, a salt, activated charcoal, and vermiculite. This system is activated by exposure to air, which begins the chemical reaction. One useful chemical system comprises a self-heating chemical mixture of iron powder, water, a salt, activated charcoal, and vermiculite contained in an air permeable porous pouch.

### BRIEF DESCRIPTION OF THE DRAWINGS

FIG. 1 is a front perspective view of a heat pack according to the present invention.

FIG. 2 is an side elevational, partially broken-away view of a exemplary package, namely an cartridge useful for containing a dental material and being of the type conducive to being heated by the heat pack of FIG. 1, for background purposes.

FIG. 3 is a front elevational view of an outer container for the heat pack of FIG. 1.

FIG. 4 is a front perspective view of a dispensing gun with a heat pack in place for heating a dental cartridge.

### PREFERRED EMBODIMENTS FOR CARRYING OUT THE INVENTION

As stated above, it is often useful in the dental arts and in fact many different arts, to heat or warm materials prior to their use. Such materials may benefit from heating for a variety of reasons including for example, to assist in viscosity reduction to promote flow and delivery, to catalyze, initiate or otherwise induce or promote a chemical reaction, and the like. An example of an cartridge useful for containing a dental material is shown for background purposes as cartridge 10 in FIG. 2. Cartridge 10 is of the type having a body member 11 with an internal cavity 12 for containing a dental or other material (the material not being shown). It is provided with a dispensing spout 14 covered by a removable cap 16. After being filled with the dental material, cavity 12 is closed by a moveable piston 18. An operator causes piston 18 to move in a direction toward spout 14, thereby physically pushing material contained within cavity 12 toward spout 14. After cap 16 has been removed, this movement of piston 18 causes the material to be dispensed from spout 14. Cartridge 10 is conventional in the art and is merely one example of a heatable package for a material, in this case a dental material, with which the present invention is useful. Any package that can be heated so as to heat the material contained therein is useful with the present invention, whether it be a box, bag, cartridge, tube, bottle or any other such container without limitation. The container such as cartridge 10 should be conductive of heat sufficiently to allow heat to permeate therethrough and to heat the material contained therein. All such packages and containers will be exemplified herein by dental cartridge 10.

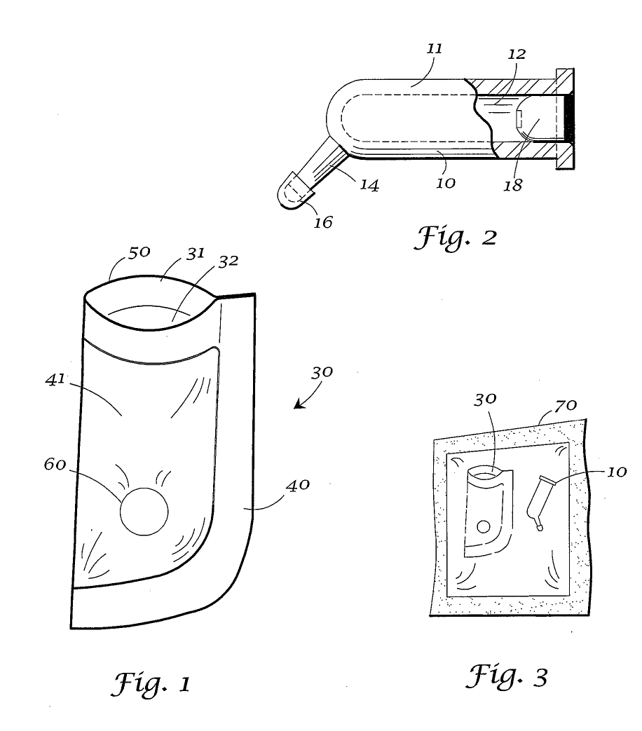

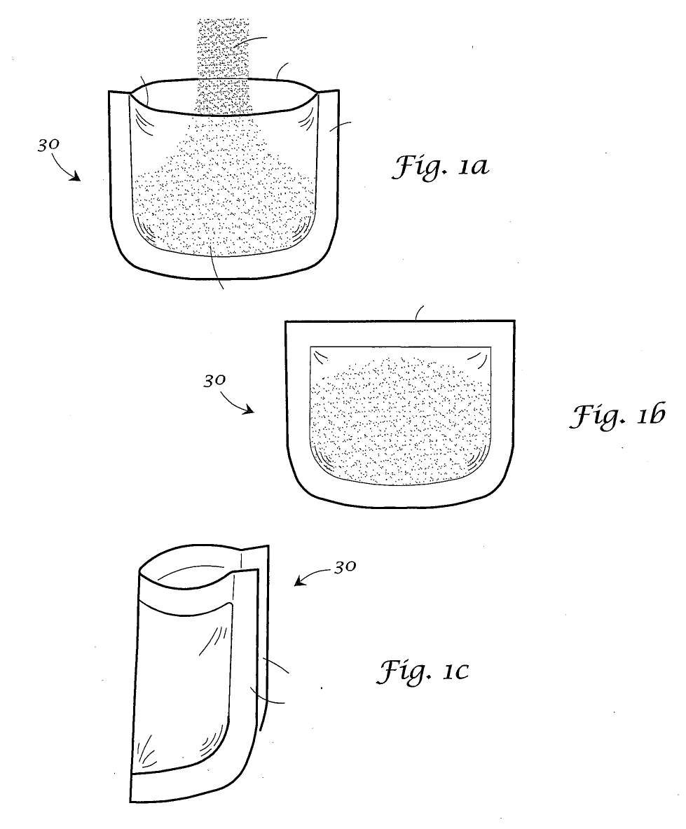

As shown in FIG. 1, an exemplary heat pack according to the concepts of the present invention is generally designated by the number 30. Heat pack 30 is envelope or sock-shaped such that it has at least one open end such as end 31. An open cavity 32 is contained within heat pack 30. Open end 31 and cavity 32 are configured so as to receive at least portion and preferably all of cartridge 10 therethrough and therein respectively. Heat pack 30 is preferably of the type that upon exposure to air an exothermic reaction takes place at a predetermined temperature and for a predetermined time, based upon the material being heated.

The shape and construction of heat pack 30 is not necessarily a limitation of the invention. For example, heat pack 30 may be pillow-shaped such that the exothermic chemical components are contained therein. Heat pack 30 may also separately hold components that when mixed cause the appropriate reaction. Further, any material of construction for heat pack 30 is within the scope of the invention, such as a spun fiber fabric or other material. Any and all such constructions are within the scope of the invention.

One way to form heat pack 30 into a useful configuration is to begin with a pillow-shaped pouch containing the self-heating chemical mixture. The pillow-shaped pouch is sealed on three or four sides. The pillow-shaped pouch is then folded in half and two edges are sealed or joined together forming heat pack 30 as shown in FIG. 1.

It is another aspect of the present invention to provide temperature indicia 60 so that an operator can determine when the proper temperature has been reached or even to determine that the heating has taken place for a sufficient period of time. Any such indicia is within the scope of the present invention. Exemplary indicia 60 is a label that is affixed to heat pack 30. When the appropriate temperature has been reached and/or when the appropriate temperature has been maintained for a predetermined period of time, indicia 60 is induced to provide a visual reference of the same. For example, indicia 60 my change color, a word may appear, or the like. Similarly, heat pack 30 itself may be fabricated from a material that changes color or the like, such that heat pack 30 or a portion thereof itself constitutes and carries out the function of indicia 60. Further still, cartridge 10 may have similar characteristics.

It will be appreciated that envelope-shaped heat pack 30 is merely one example of a heat pack within the scope of the present invention. Other heat packs within the scope of the invention (not shown) could be flat or sheet-like, boxes, bags, bottles, rigid or non-rigid in structure or the like. In addition, a separate non-heating container (not shown) could be provided such that the cartridge 10 and a heat pack are placed therein to induce heating of the cartridge 10. All such constructions are within the scope of the invention and are exemplified by heat pack 30 in the drawings.

If heat pack 30 is of the type wherein the exothermic reaction is initiated upon exposure to air, then it would be necessary to place heat pack 30 into an air-barrier package 70 as shown in FIG. 3. Air-barrier package 10 may be provided for simplicity with a heat pack 30 and an cartridge 10 as one package. In use, the operator would open air-barrier package 70 thus exposing heat pack 30 to the air and initiating the exothermic chemical reaction. Cartridge 10 is then placed into heat pack 30 as above described. Air-barrier package 70 may be fabricated from any suitable material. Alternatively, cartridge 10 may be conveniently prepackaged within heat pack 30 so that when air-barrier package 70 is opened, a second step to place cartridge 10 in heat pack 30 is not necessary.

Similarly, it is not necessary to package cartridge 10 with heat pack 30. Heat pack 30 may be packaged individually in air-barrier package 70. One convenient method of using this invention is to load cartridge 10 into the tip of a dispensing gun 80. Once heat pack 30 is removed from air-barrier package 70, the heat pack is slipped over the end of the dispensing gun 80 enveloping cartridge 10 as heat pack 30 starts to heat up.

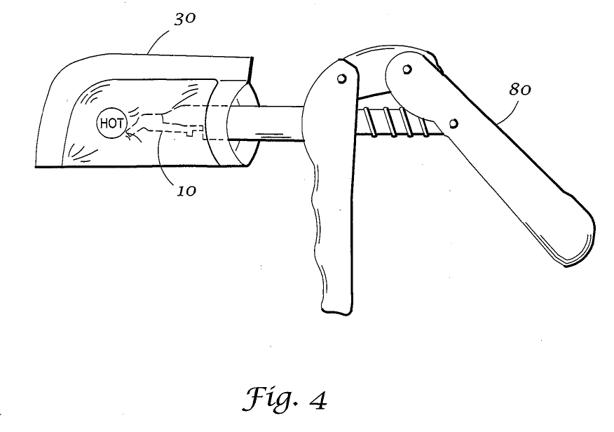

The exothermic reaction time of heat pack 30 can occur slowly over several hours or rapidly over several minutes depending on the formula of the self-heating chemical mixture contained in heat pack 30, the mass of the chemical mixture and the amount of air exposure. In on experiment, a single use heat pack 30 with 15 g of self-heating chemical mixture was placed on a dispensing gun that was pre-loaded with a dental cartridge as in FIG. 4. The contents of cartridge 10 reached 60° C. in about 2 minutes and remained above 60° C. for about 20 minutes. With a relatively small mass of self heating chemical mixture and unrestricted air exposure the exothermic reaction continues rapidly and goes to completion quickly. Such a system would be suitable for single use applications.

In another experiment, a larger multiple use heat pack with 47 g of self-heating chemical mixture was rolled up and placed inside a close fitting cylindrical chamber with air vents that could be opened or closed to control the amount of air exposure. Once the exothermic reaction was initiated, the temperature inside the heat pack rose from 23° C. to 60° C. within approximately 30 minutes. The temperature remained between 60° C. and 70° C. for approximately 6 hours. With a larger mass of self-heating chemical mixture and a restricted air supply the exothermic reaction continued slowly and went to completion much slower than the single use system previously described. When a room temperature (23° C.) cartridge 10 was loaded into a dispensing gun 80 and inserted into the center of cartridge 10 to reach 60° C. Such a system would be suitable for multiple uses throughout the course of a day because of the long reaction time.

It should be apparent therefore that a heat pack as shown and described accomplishes the concepts of the present invention. The invention has been exemplified herein and on the drawings without attempting to show all embodiments within the scope thereof. The scope of the invention shall be limited only be any attached claims.

What is claimed is:

1. A method of heating a dental material contained in a package, comprising exposing the package to heat generated by an exothermic chemical reaction.

2. A method as in claim 1, wherein said step of exposing the package to heat includes inducing an exothermic chemical reaction within a heat pack.

3. A method as in claim 2, wherein said step of exposing includes physically contacting the package and said heat pack.

4. A method as in claim 1, wherein said exothermic chemical reaction results from the mixture of iron powder, water, a salt, activated charcoal, vermiculite and air.

5. A method as in claim 2, wherein said heat pack is in the shape of an envelope, such that the package may be placed within the envelope.

6. A heat pack for heating a packaged dental material comprising a fabric enclosing a mixture of ingredients which can be induced to react to produce heat.

7. A heat pack as in claim 6, wherein said fabric is configured to receive the packaged dental material.

8. A heat pack as in claim 7 wherein said fabric is in the shape of an envelope having an open end for receiving the packaged dental material.

9. A heat pack as in claim 6, further comprising a temperature indicia.

10. A heat pack as in claim 9 wherein said indicia is in the form of a label affixed to said fabric.

11. A heat pack as in claim 6, wherein said fabric is caused to produce an indicia upon reaching a predetermined temperature.
